(19) United States
(12) Patent Application Publication
(10) Pub. No.: US 2026/0067382 A1
(43) Pub. Date: Mar. 5, 2026

(54) DISTRIBUTED TAG MATCHING

(71) Applicant: MELLANOX TECHNOLOGIES, LTD., Yokneam (IL)

(72) Inventors: Richard Leigh Graham, Knoxville, TN (US); George Bosilca, Knoxville, TN (US); Artem Yuryevich Polyakov, San Francisco, CA (US); Yong Qin, Lafayette, CA (US); Geoffroy Regis Vallee, Oak Ridge, TN (US)

(21) Appl. No.: 18/816,225

(22) Filed: Aug. 27, 2024

(51) Int. Cl. H04L 69/22; G06F 9/54

(52) U.S. Cl. CPC H04L 69/22; G06F 9/546

(57) ABSTRACT

Embodiments of the present disclosure are directed to distributed matching of messages to an intended recipients when the message is processed as a wildcard receive by a recipient node. Generally speaking, embodiments described herein address distributed tag-matching in the presence of matching tags with wild-carded receives and that considers parameters not associated with the matching-tag which are not known to both the sender and receiver a priori.

### FIELD OF THE DISCLOSURE

The present disclosure is generally directed to computer communications and more particularly to distributed matching of messages to intended recipients when the message may include a wildcard designation in place of a source identifier in the message.

### BACKGROUND

The Message Passing Interface (MPI) specification tag matching, and other Application Programming Interfaces (APIs) with similar semantics, define a protocol by which a sender can initiate a data transfer. The receiver can independently post a receive request. Tag-matching rules define how to pair the two operations in order to deliver the data to the appropriate receive address in memory. The items matching rules require: ordering of send operations based on the order in which the sender sends the messages; ordering of the receive operations based on the order in which the receiver posts the receive requests; a tag associated with the sender; a tag associated with the receiver; matching of the send and receive tags to determine where data is to be delivered, e.g., send and receive tags must match; and ordered matching, e.g. when more than one possible match exists between the sender and the receiver, the required match is the one for which the earliest message sent is matched against the earliest receive message. Of the four parameters involved in MPI tag matching, i.e., source, destination, user-tag, and communicator, two can be wild carded, namely, source and user-tag. The user-tag wild carding is not of concern herein.

The posted receive request may include a wildcard for the source of the data, in which case the tag matching element wild-carded will match that field in any of the posted send tags. However, a given pair of tags, i.e., in the message and the receive request, may be matched only once. The ordering requirements make it a challenge to distribute the MPI tag-matching between a given pair of end-points to different matching engines. The source of the problem is that a wild-carded data source can be matched against data from any source and must be matched only once. So, if such tags are distributed to different matching engines, only one such matching engine can create a match. In a previous to distributed tag matching, all tag-matching is moved to a single matching engine while tags with wild-carded data sources are available for matching, and then distributed tag-matching is resumed once these are matched. This decreases the efficiency of the distributed approach to tag matching. Hence, there is a need in the art for improved methods and systems for distributed tag-matching in the presence of tags with wild-carded data sources.

### BRIEF SUMMARY

Embodiments of the present disclosure are directed to distributed matching of messages to an intended recipients when the message is processed as a wildcard receive by a recipient node. Generally speaking, embodiments described herein address distributed tag-matching in the presence of matching tags with wild-carded receives and that considers parameters not associated with the matching-tag which are not known to both the sender and receiver a priori.

According to one embodiment, a computing device can comprise a control circuit controlling operation of the computing device. The control circuit can cause the computing device to execute an application process which initiates a post receive to request receipt of a message and determines whether to process the post receive as a wildcarded post receive. In response to determining to not process the post receive as a wildcarded post receive, the post receive can be provided to a target matching engine of a plurality of matching engines and the target matching engine can perform matching of the post receive to a received message. In response to determining to process the post receive as a wildcarded post receive, the post receive can be distributed to each of one or more target matching engines of the plurality of matching engines, wherein when the one or more target matching engines comprises two or more distributed matching engines, each of the two or more target matching engines perform parallel matching of the post receive to a received message.

Performing matching of the post receive to a received message can comprise comparing the post receive to an unmatched message list and determining whether the post receive matches a received message in the unmatched message list. In response to determining the post receive does not match a received message in the unmatched message list, the post receive can be added to the unmatched message list.

Matching of the post receive to a received message can further comprises, in response to determining the post receive matches a received message in the unmatched message list, determining whether the post receive is a wildcarded post receive. In response to determining the post receive is not a wildcarded post receive, the match between the post receive and the message in the unmatched message list can be processed. In response to determining the post receive is a wildcarded post receive, a matching token can be requested from a token manager.

Performing matching of the post receive to a received message can further comprise determining whether the requested matching token has been granted. In response to determining the requested matching token has been granted, the match between the post receive and the message in the unmatched message list can be processed. In response to determining the requested matching token has not been granted, the matching message can be removed from the unmatched message list and the token manager can be notified of a failed request.

Processing the match between the post receive and the message in the unmatched message list can comprise determining whether a current domain for the matching engine performing the matching is a domain for processing data of the matched message. In response to determining the current domain for the matching engine performing the matching is the domain for processing data of the matched message, a receive protocol for the data of the message can be initiated and the matched message can be removed from the unmatched message list. In response to determining the current domain for the matching engine performing the matching is not the domain for processing data of the matched message the post receive can be marked as complete in a matching table and the matched message can be removed from the unmatched message list.

According to another embodiment, a distributed computing network can comprise a communication network and a first processing node coupled with the communication network. The first processing node can comprise a control circuit controlling operation of the first processing node, wherein the control circuit causes the first processing node to execute an application process which sends messages via the communication network.

The distributed computing network can further comprise a second processing node coupled with the communication network. The second processing node can comprise a control circuit controlling operation of the second processing node, wherein the control circuit causes the second processing node to execute an application process. The application process executing on the second processing node can comprise a distributed matching engine of a plurality of distributed matching engines which can receive the message from the first processing node and determine, based on a header of the message, whether the message matches a previous post receive. In response to determining the message does not match a previous post receive, the application process executing on the second processing node can add the message to an unexpected message list.

In response to determining the message matches a previous post receive, the application process executing on the second processing node can determine whether to process the post receive as a wildcarded post receive. In response to determining to not process the post receive as a wildcarded post receive, the application process executing on the second processing node can process the message.

In response to determining to process the post receive as a wildcarded post receive, the application process executing on the second processing node can request a matching token from a token manager and determine whether the matching token has been granted. In response to determining the matching token has been granted, the application process executing on the second processing node can process the message. In response to determining the matching token has not been granted, the application process executing on the second processing node can remove a matching receive message from an unmatched receive list and continue with determining, based on a header of the message, whether the message matches any previous post receive.

According to yet another embodiment, a method for data communication in a distributed computing network can comprise initiating a post receive to request receipt of a message and determining whether to process the post receive as a wildcarded post receive. In response to determining to not process the post receive as a wildcarded post receive, the post receive can be provided to a target matching engine of a plurality of matching engines to perform matching of the post receive to a received message. In response to determining to process the post receive as a wildcarded post receive, the post receive can be distributed to each of one or more target matching engines of the plurality of matching engines to perform matching of the post receive to a received message, wherein when the one or more target matching engines comprises two or more distributed matching engines, each of the two or more target matching engines perform parallel matching of the post receive to a received message.

Performing matching of the post receive to a received message can comprise comparing the post receive to an unmatched message list and determining whether the post receive matches a received message in the unmatched message list. In response to determining the post receive does not match a received message in the unmatched message list, the post receive can be added to the unmatched message list.

In response to determining the post receive matches a received message in the unmatched message list a determination can be made as to whether the post receive is a wildcarded post receive. In response to determining the post receive is not a wildcarded post receive, the match between the post receive and the message in the unmatched message list can be processed.

In response to determining the post receive is a wildcarded post receive, requesting a matching token from a token manager. A further determination can be made as to whether the requested matching token has been granted. In response to determining the requested matching token has been granted, the match between the post receive and the message in the unmatched message list can be processed. In response to determining the requested matching token has not been granted the matching message can be removed from the unmatched message list and the token manager can be notified of a failed request.

Processing the match between the post receive and the message in the unmatched message list can comprise determining whether a current domain for the matching engine performing the matching is a domain for processing data of the matched message. In response to determining the current domain for the matching engine performing the matching is the domain for processing data of the matched message, a receive protocol can be initiated for the data of the message and the matched message can be removed from the unmatched message list. In response to determining the current domain for the matching engine performing the matching is not the domain for processing data of the matched message, the post receive can be marked as complete in a matching table and the matched message can be removed from the unmatched message list.

### BRIEF DESCRIPTION OF THE SEVERAL VIEWS OF THE DRAWINGS

The present disclosure is described in conjunction with the appended figures, which are not necessarily drawn to scale.

FIG. 1 is a block diagram illustrating an exemplary environment in which tag matching can be performed according to one embodiment of the present disclosure.

FIG. 2 is a flowchart illustrating an exemplary process for sending data communication in a distributed computing network according to one embodiment of the present disclosure.

FIG. 3 is a flowchart illustrating an exemplary process for posting a receive in a distributed computing network according to one embodiment of the present disclosure.

FIG. 4 is a flowchart illustrating additional details of an exemplary process for distributed matching according to one embodiment of the present disclosure.

FIG. 5 is a flowchart illustrating additional details of an exemplary process for processing a posted receive match according to one embodiment of the present disclosure.

FIG. 6 is a flowchart illustrating an exemplary process for receiving a message over a distributed computing network according to another embodiment of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material. ”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

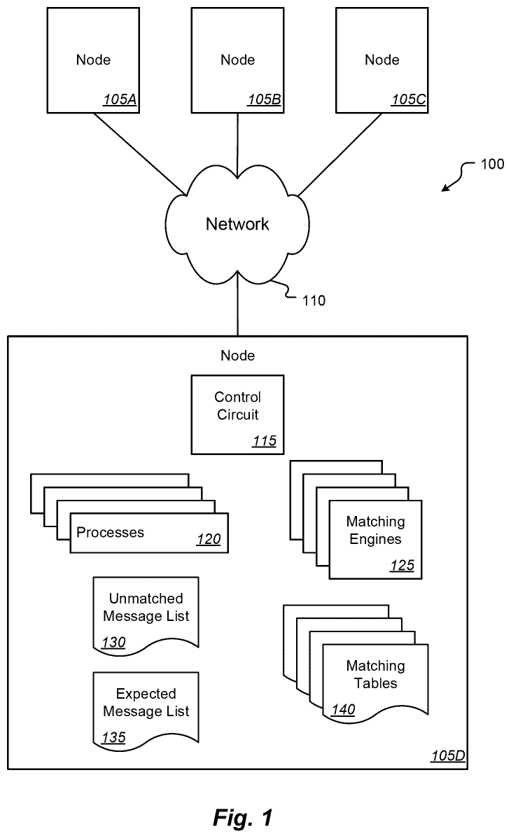

Referring now to FIGS. 1-5, various systems and methods for processing of communications in a distributed computing network will be described. Embodiments described herein are directed to the distributed matching of messages to an intended recipients when the message is processed by a recipient as a wildcard receive. Furthermore, embodiments described herein consider parameters not associated with the matching-tag.

FIG. 1 is a block diagram illustrating an exemplary environment in which tag matching can be performed according to one embodiment of the present disclosure. As illustrated in this example, the environment 100 can comprises a number of nodes 105A-105D coupled with a communication network 110. As used herein, a node refers to the system unit that is replicated to create a distributed computing system. For example, this may include CPUs, Graphic Processing Units (GPUs) and several network cards. Such units would be connected via a network to create a distributed computer system.

As exemplified by node 105D, each of the nodes can comprise a control circuit 115 controlling operation of the node 105D. The control circuit 115 can comprise a Central Processing Units (CPUs), e.g., one or more microprocessors, or similar components as known in the art. The control circuit 115 of the node can execute any number of processes 120 communicating over the communication network 110 with processes executing on other nodes 105A-105C, or within memory of a single node 105D, via Message Passing Interface (MPI) specification or similar Application Programming Interface (API) as known in the art. When a parallel job is running, each such system will have one or more processes 120 running on each node 105A-105D. If an MPI library is being used to manage the data exchange between these processes 120 (on or off host), these processes 120 are referred to as MPI processes, and each such process has one or matching engines 125. Embodiments of the present disclosure are directed to distributing the matching within the single MPI process, while keeping the tag matching being performed conformant to the MPI specification.

The data transfers can be either between processes on different nodes, or on the same node. The matching for a single MPI process will be distributed across some of the system components. Within a single process they may be distributed across several threads, network cards, GPUs, and/or other components. In some embodiments two such components can comprise a host operating system process and a BlueField network card operating system process.

As introduced above, embodiments of the present disclosure are directed to matching messages sent between two endpoints, e.g., a sender process and recipient process executing within a node 105D or across any one or more nodes 105A-105D and taking into account parameters that are not part of the matching criteria. In some cases, the length of the posted receive can be larger than that of the actual data sent. In such case, the receiver really can't predict to which of the matching engines 125 the message will actually be sent to by the sender. The sender causes the matching header to be delivered to all relevant matching engines. The sender knows which matching engine will initiate the data delivery, but the receiver does not know that until it gets the matching header from the sender and determines actual message length. It should be noted that, length is just one parameter that can be used to determine which engine delivers the data, but others are possible.

The execution of ordered tag matching is most efficient when done in a single matching engine 125 as all relevant data is cheaply accessible. A matching engine 125 that is most often used is one associated with the process's application memory context, as the operations that initiate the tag matching (usually the posting of the receive operation) are done in this context. However, since this is often the context in which the non-communication portion of the application also executes, such matching tends to be synchronous and is done only when the application is executing in the context of a communication library. Network library processing and non-network processing compete for the same computational resources. In instances where an asynchronous agent exists, it is desirable to use it to progress communication, and in this case perform tag matching independently overlapping with the other aspects of the application, such as computation, with communication. Such an asynchronous agent can comprise a DPU, CPU, or other processing node. When it is desirable to split the tag-matching between different contexts, with the using both the sender and receiver tags as the parameters to determine in which context the tag matching will be performed, the challenge that emerges is one of keeping the contexts coherent as the tag matching is performed, to ensure each tag is used only once in a successful match.

Message size is frequently used when determining the best way to transfer point-to-point data over the network, with eager protocols often used to send short data and rendezvous protocols to send the longer data. In the eager protocol, the sender sends the entire message to the receiver along with the matching header, where the receiver provides sufficient buffering space for the incoming messages. A rendezvous protocol uses a handshaking model, unlike an eager protocol which directly copies the data. In a rendezvous protocol the data is sent when the destination says it is ready, but in an eager protocol the data is sent assuming the destination can store the data in a temporary location if the match can't be made when the header arrives. For performance reasons, it is desirable to perform the short message tag-matching in the memory context of a main process to minimize its cost in terms of time or latency and longer message tag matching using an asynchronous agent to be able to progress the rendezvous protocol independently of the applications computation.

The actual length of data being transferred is known at data transfer initiation only on the sender side, with the receiver being able to expose a maximal buffer length, so when the receiver-side matching-tag is posted, the receiver does not know if the protocol used to deliver the data will be eager or rendezvous. If the posted receive is for short data, it knows that an eager match will be performed, per MPI specification. If it is for a large message, the receiver does not know if an eager or rendezvous protocol will be used.

According to one embodiment, a sender process can deliver to a recipient process a matching header that can be used by a matching engine 125 for the recipient process. The recipient process can also post the receive tags to each matching engine 125. When the recipient process completes the tag matching, it will know in which context the data will be delivered, as each matching engine 125 uses the same logic to determine this. Since the sender process is aware up front which context will process the data associated with the match, the protocol specific data, such as the payload in an eager match, can be delivered to the receive context processing the received data. If data layout is used to determine which matching engine processes the data at the receive side, which is a possible criteria, the sender does not know who will process the arriving data. Only the receiver knows that.

According to one embodiment, when delivering the data to the recipient process, the matching headers to a given context that will not be used for data delivery do not need to be sent to that context until a matching tag that will be processed by that context is issued. This allows reducing the network costs for those matching tags are used only to ensure the correct ordered matching.

According to one embodiment, a master matching table 140 can be used in which all wild-carded receive matching-tags can be represented as an entry and tracked. Each entry in the tables 140 can include a field that indicates if the tag has been matched or not. The access “address” to that field can be distributed with the receive matching-tags as they are distributed to each matching engine 125. When a given context can match a particular matching tag, it can request the rights for matching that wild-carded posted receive tag, and if granted, can initiate the process of delivering the data from the sender process to the recipient process. If not, that context recognized this receive tag as previously matched, and will not re-use the posted-receive matching tag. For example, the field address might be the network address of the field, which can be accessed via an atomic update.

Once a matching engine 125 matches one of the wild-carded receive matching-tags, it can notify the other matching engines 125 of the match. According to one embodiment, the entity that owns or is otherwise responsible for maintaining the master matching table 140 can remove this entry once all matching engines 125 have notified it of removal from their matching lists, to ensure the entry is not re-used prematurely.

In embodiments with multi-matching-context optimization, local-host-based tag matching can proceed at on-host processing speeds, which are usually higher than inter-host speeds. These also do not consume network resources. Inter-host tag-matching can proceed with the separate inter-host resources. In addition, when multiple inter-host resources are available, the matching can be further distributed.

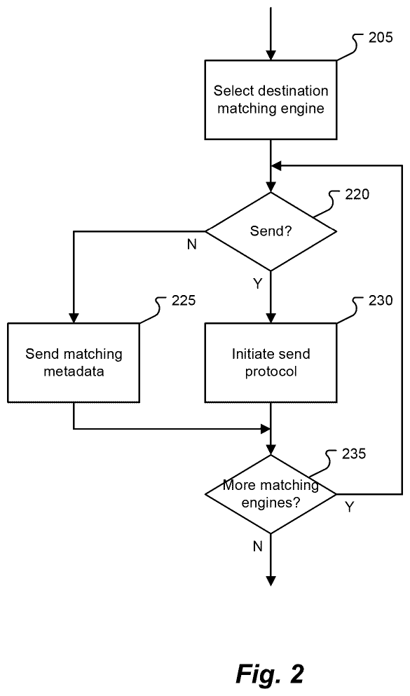

FIG. 2 is a flowchart illustrating an exemplary process for sending data communication in a distributed computing network according to one embodiment of the present disclosure. As illustrated in this example, sending data communication in a distributed computing network can begin with a sender process selecting 205 destination or target matching engines to which the message should be sent. A determination 220 can be made as to whether to send the message to each matching engine. In response to determining 220 to not send the message to a particular matching engine, matching metadata can be sent 225 and in response to determining to send the message to that particular matching engine, the send protocol can be initiated 230 to send the message. In either case, a further determination 235 can be made as to whether more selected target matching engines remain. If so, the process can repeat determining 220 whether to send the message to remaining target matching engines and either sending 225 matching metadata or initiating 230 the send protocol until no selected matching engines remain.

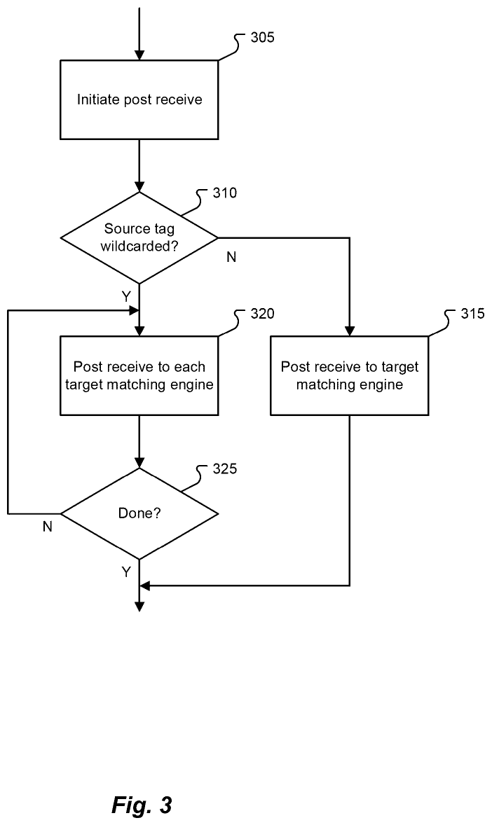

FIG. 3 is a flowchart illustrating an exemplary process for posting a receive in a distributed computing network according to one embodiment of the present disclosure. As illustrated in this example, the process can begin with initiating 305 a post receive to request receipt of a message and determining 310 whether to process the post receive as a wildcarded post receive. Alternatively, for a message received from another processing node, a determination can be made, based on a header of the message, whether the message matches a previous post receive and in response to determining the message matches a previous post receive, a determination 310 can be made as to whether to process the post receive as a wildcarded post receive.

In response to determining 310 to not process the post receive as a wildcarded post receive, the post receive can be provided 315 to a target matching engine of a plurality of matching engines and the target matching engine can perform matching of the post receive to a received message. In response to determining 310 to process the post receive as a wildcarded post receive, the post receive can be distributed 320 to each of one or more target matching engines of the plurality of matching engines, wherein when the one or more target matching engines comprises two or more distributed matching engines, each of the two or more target matching engines perform parallel matching of the post receive to a received message. Distributing 320 to each of two or more target matching engines of the plurality of matching engines can continue until a determination 325 is made that the post receive has been distributed to all intended matching engines.

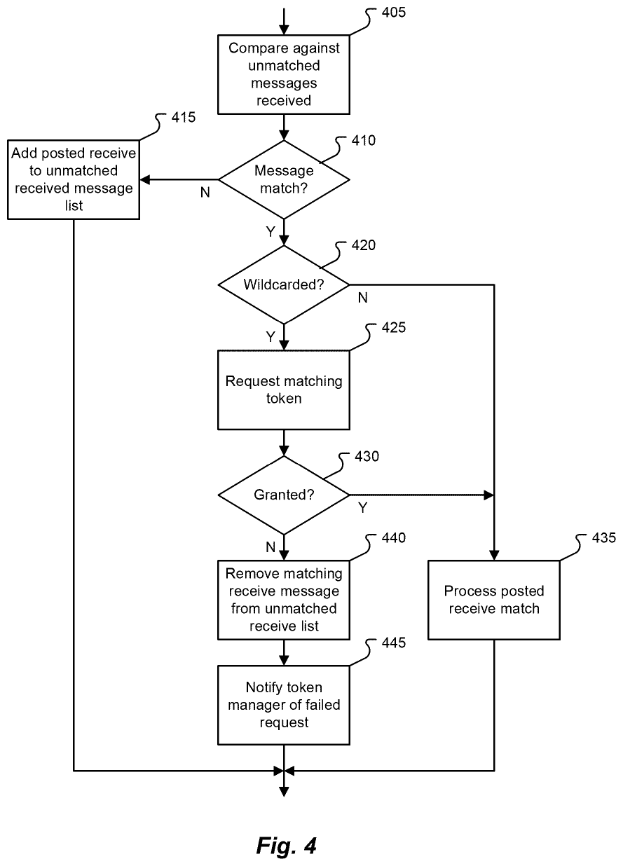

FIG. 4 is a flowchart illustrating additional details of an exemplary process for distributed matching according to one embodiment of the present disclosure. As illustrated in this example, performing matching of the post receive to a received message can comprise comparing 405 the post receive to an unmatched message list and determining 410 whether the post receive matches a received message in the unmatched message list. In response to determining 410 the post receive does not match a received message in the unmatched message list, the post receive can be added 415 to the unmatched message list.

Matching of the post receive to a received message can further comprises, in response to determining 410 the post receive matches a received message in the unmatched message list, determining 420 whether the post receive is a wildcarded post receive. In response to determining 420 the post receive is not a wildcarded post receive, the match between the post receive and the message in the unmatched message list can be processed 435. In response to determining 420 the post receive is a wildcarded post receive, a matching token can be requested 425 from a token manager.

Performing matching of the post receive to a received message can further comprise determining 430 whether the requested matching token has been granted. In response to determining 430 the requested matching token has been granted, the match between the post receive and the message in the unmatched message list can be processed 435. In response to determining 430 the requested matching token has not been granted, the matching message can be removed 440 from the unmatched message list and the token manager can be notified 445 of a failed request.

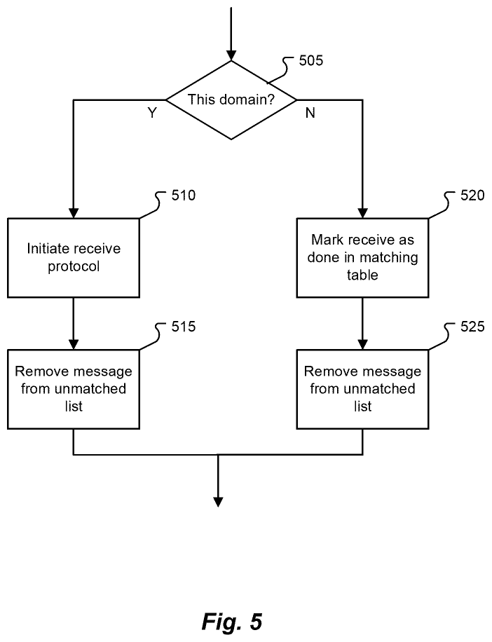

FIG. 5 is a flowchart illustrating additional details of an exemplary process for processing a posted receive match according to one embodiment of the present disclosure. As illustrated in this example, processing the match between the post receive and the message in the unmatched message list can comprise determining 505 whether a current domain for the matching engine performing the matching is a domain for processing data of the matched message. In response to determining 505 the current domain for the matching engine performing the matching is the domain for processing data of the matched message, a receive protocol for the data of the message can be initiated 510 and the matched message can be removed 515 from the unmatched message list. In response to determining 505 the current domain for the matching engine performing the matching is not the domain for processing data of the matched message the post receive can be marked 520 as complete in a matching table and the matched message can be removed 525 from the unmatched message list.

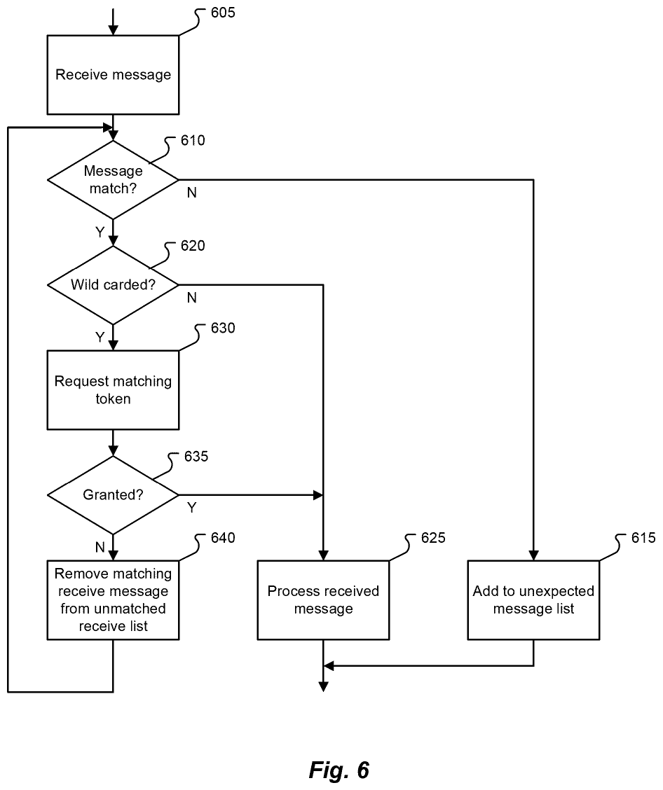

FIG. 6 is a flowchart illustrating an exemplary process for receiving a message over a distributed computing network according to another embodiment of the present disclosure. As illustrated in this example, the process can comprise receiving 605 the message from a processing node of the distributed computing network and determining 610, based on a header of the message, whether the message matches a previous post receive. In response to determining 610 the message does not match a previous post receive, the message can be added 615 to an unexpected message list.

In response to determining 610 the message matches a previous post receive, a further determination 620 can be made as to whether to process the post receive as a wildcarded post receive. In response to determining 620 to not process the post receive as a wildcarded post receive, the message can be processed 625.

In response to determining 620 to process the post receive as a wildcarded post receive, a matching token can be requested 630 from a token manager and a determination 635 can be made as to whether the matching token has been granted. In response to determining 635 the matching token has been granted, the message can be processed 625. In response to determining 635 the matching token has not been granted, a matching receive message can be removed 640 from an unmatched receive list and continue with determining 610, based on a header of the message, whether the message matches any previous post receive.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A computing device comprising:
a control circuit controlling operation of the computing device, wherein the control circuit causes the computing device to execute an application process, and wherein the application process:
initiates a post receive to request receipt of a message;
determines whether to process the post receive as a wildcarded post receive;
in response to determining to not process the post receive as a wildcarded post receive, provides the post receive to a target matching engine of a plurality of matching engines, wherein the target matching engine performs matching of the post receive to a received message; and
in response to determining to process the post receive as a wildcarded post receive, distributes the post receive to each of one or more target matching engines of the plurality of matching engines, wherein when the one or more target matching engines comprises two or more distributed matching engines, each of the two or more target matching engines perform parallel matching of the post receive to a received message.

2. The computing device of claim 1, wherein performing matching of the post receive to a received message comprises:
comparing the post receive to an unmatched message list;
determining whether the post receive matches a received message in the unmatched message list; and
in response to determining the post receive does not match a received message in the unmatched message list, adding the post receive to the unmatched message list.

3. The computing device of claim 2, wherein performing matching of the post receive to a received message further comprises, in response to determining the post receive matches a received message in the unmatched message list:
determining whether the post receive is a wildcarded post receive;
in response to determining the post receive is not a wildcarded post receive, processing the match between the post receive and the message in the unmatched message list; and
in response to determining the post receive is a wildcarded post receive, requesting a matching token from a token manager.

4. The computing device of claim 3, wherein performing matching of the post receive to a received message further comprises:
determining whether the requested matching token has been granted; and
in response to determining the requested matching token has been granted, processing the match between the post receive and the message in the unmatched message list.

5. The computing device of claim 4, wherein performing matching of the post receive to a received message further comprises, in response to determining the requested matching token has not been granted:
removing the matching message from the unmatched message list; and
notifying the token manager of a failed request.

6. The computing device of claim 4, wherein processing the match between the post receive and the message in the unmatched message list comprises:
determining whether a current domain for the matching engine performing the matching is a domain for processing data of the matched message; and
in response to determining the current domain for the matching engine performing the matching is the domain for processing data of the matched message, initiating a receive protocol for the data of the message and removing the matched message from the unmatched message list.

7. The computing device of claim 6, further comprising, in response to determining the current domain for the matching engine performing the matching is not the domain for processing data of the matched message:
marking the post receive as complete in a matching table; and
removing the matched message from the unmatched message list.

8. A distributed computing network comprising:
a communication network;
a first processing node coupled with the communication network and comprising a control circuit controlling operation of the first processing node, wherein the control circuit causes the first processing node to execute an application process, and wherein the application process sends messages via the communication network; and
a second processing node coupled with the communication network and comprising a control circuit controlling operation of the second processing node, wherein the control circuit causes the second processing node to execute an application process, and wherein the application process:
receives the message from the first processing node;
determines, based on a header of the message, whether the message matches a previous post receive; and
in response to determining the message matches a previous post receive, determines whether to process the post receive as a wildcarded post receive.

9. The distributed computing network device of claim 8, wherein the application process executing on the second processing node, in response to determining the message does not match a previous post receive, adds the message to an unexpected message list.

10. The distributed computing network of claim 8, wherein the application process executing on the second processing node, in response to determining to not process the post receive as a wildcarded post receive, processes the message.

11. The distributed computing network of claim 8, wherein the application process executing on the second processing node, in response to determining to process the post receive as a wildcarded post receive, requests a matching token from a token manager and determines whether the matching token has been granted.

12. The distributed computing network of claim 11, wherein the application process executing on the second processing node, in response to determining the matching token has been granted, processes the message.

13. The distributed computing network of claim 11, wherein the application process executing on the second processing node, in response to determining the matching token has not been granted, removes a matching receive message from an unmatched receive list and continue with determining, based on a header of the message, whether the message matches any previous post receive.

14. The distributed computing network of claim 8, wherein the application process executing on the second processing node comprises a distributed matching engine of a plurality of distributed matching engines.

15. A method for data communication in a distributed computing network, the method comprising:
initiating, by an application process executed by a control circuit of a computing device, a post receive to request receipt of a message;
determining, by the application process executed by the control circuit of a computing device, whether to process the post receive as a wildcarded post receive;
in response to determining to not process the post receive as a wildcarded post receive, providing, by the application process executed by the control circuit of a computing device, the post receive to a target matching engine of a plurality of matching engines, wherein the target matching engine performs matching of the post receive to a received message; and
in response to determining to process the post receive as a wildcarded post receive, distributing, by the application process executed by the control circuit of a computing device, the post receive to each of one or more target matching engines of the plurality of matching engines, wherein when the one or more target matching engines comprises two or more distributed matching engines, each of the two or more target matching engines perform parallel matching of the post receive to a received message.

16. The method of claim 15, wherein performing matching of the post receive to a received message comprises:
comparing the post receive to an unmatched message list;
determining whether the post receive matches a received message in the unmatched message list; and
in response to determining the post receive does not match a received message in the unmatched message list, adding the post receive to the unmatched message list.

17. The method of claim 16, wherein performing matching of the post receive to a received message further comprises, in response to determining the post receive matches a received message in the unmatched message list:
determining whether the post receive is a wildcarded post receive;
in response to determining the post receive is not a wildcarded post receive, processing the match between the post receive and the message in the unmatched message list; and
in response to determining the post receive is a wildcarded post receive, requesting a matching token from a token manager.

18. The method of claim 17, wherein performing matching of the post receive to a received message further comprises:
determining whether the requested matching token has been granted; and
in response to determining the requested matching token has been granted, processing the match between the post receive and the message in the unmatched message list.

19. The method of claim 18, wherein performing matching of the post receive to a received message further comprises, in response to determining the requested matching token has not been granted:
removing the matching message from the unmatched message list; and
notifying the token manager of a failed request.

20. The method of claim 18, wherein processing the match between the post receive and the message in the unmatched message list comprises:
determining whether a current domain for the matching engine performing the matching is a domain for processing data of the matched message;
in response to determining the current domain for the matching engine performing the matching is the domain for processing data of the matched message, initiating a receive protocol for the data of the message and removing the matched message from the unmatched message list; and
in response to determining the current domain for the matching engine performing the matching is not the domain for processing data of the matched message, marking the post receive as complete in a matching table and removing the matched message from the unmatched message list.
